(19) United States
(12) Patent Application Publication
(10) Pub. No.: US 2008/0039005 A1
(43) Pub. Date: Feb. 14, 2008

(54) PORTABLE FUME EXHAUSTER-CARPET AND FLOOR DRYER

(76) Inventor: Steven R. Coven, Highland Park, IL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/697,519

(22) Filed: Apr. 6, 2007

Related U.S. Application Data
(63) Continuation-in-part of application No. 10/795,824, filed on Mar. 8, 2004, now abandoned.
Application No. 10/795,824 is a continuation-in-part of application No. 10/268,550, filed on Oct. 10, 2002, now Pat. No. 6,702,664.

(51) Int. Cl. F24F 7/007; F26B 21/00

(52) U.S. Cl. 454/234; 34/523

(57) ABSTRACT

A portable fume exhauster and dryer includes a motor fall mounted in a housing having a supporting structure adapted to rest on a horizontal surface, such as a floor, or on an uneven or slanted, often narrow surface, for example, a window sill. The housing of the exhauster and dryer has flanges at intake and exhaust openings to which grilles and/or conduits can be attached for remote intake or exhaust of fumes and moisture. Circuitry for the device may be provided to prevent electrical shock, power surges and thermal overload, and a switch may be proved for operation by an operator wearing protective clothing, such as heavy gloves.

### RELATED U.S. APPLICATION DATA

This application is a continuation-in-part of and claims the benefit of priority of prior-filed U.S. application Ser. No. 10/795,824 filed Mar. 8, 2004, which is a continuation-in-part of and claims the benefit of priority of prior-filed U.S. application Ser. No. 10/268,550 filed on Oct. 10, 2002, now U.S. Pat. No. 6,702,664. This patent application hereby incorporates the full disclosure of U.S. Pat. No. 6,702,664 and the full disclosure of U.S. Ser. No. 10/795,824 filed Mar. 8, 2004, herein by reference.

### FIELD OF THE INVENTION

This invention relates to a portable fume exhauster and dryer; and more particularly to an improved exhauster and dryer adapted to be placed on a floor, in a window or a remote location for the exhausting of fumes or the drying of floors and carpeting or the removal of dust, such as saw dust, dry wall dust and construction and remodeling dust.

### BACKGROUND OF THE INVENTION

Fumes are often created within a room or other space upon the use of cleaning compositions, compositions, such as mastics and pastes for installing tile or other wall or floor coverings; and compositions for restoring or resurfacing fixtures, such as bathtubs, showers, lavatories, and the like. These fumes often are noxious, and their rapid removal is desirable, particularly where the fumes are present in a small space, such as a bathroom.

Additionally, floors and carpeting may become damp or wet intentionally in cleaning or unintentionally by flooding or spills, and requiring drying. One preferred method of drying is to circulate air over or in the vicinity of the damp or wet areas, for example, by use of a fan.

An example of an exhaust fan for exhausting fumes is disclosed in U.S. Pat. No. 3,069,933 issued to Bora which is intended to remove fumes from welding operations. The double fan device disclosed in that patent is adapted to be installed on a work bench or pedestal and connects to a damper unit which may be placed in a window. Another example of a portable ventilation system is shown in U.S. Pat. No. 5,702,296 issued to Grano, which uses a conduit having two separate passageways for a counter-flow effect.

The known fume exhausters and dryers are deficient in that they are complex often having several separate components, and hence aye expensive, and require considerable set-up time.

Thus, there is a need fort an uncomplicated, compact, portable exhauster and dryer which can be easily installed in a short time, does not present an electrical or thermal safety hazard, can be placed on a floor or carpeted surface or can be placed on an opening in a wall, such as a window, and can be readily operated by a user wearing bulky clothing, particularly thick gloves.

### SUMMARY OF THE INVENTION

A portable fume exhauster and dryer in accordance with the present invention includes a motor fan mounted in a housing having a supporting structure which is adapted to rest on a horizontal surface, such as a floor, or on an uneven or slanted, often narrow surface, for example, a window sill. The device of the present invention includes a covering on the intake opening of the housing to prevent accidental contact with the fan apparatus and grounded circuitry to prevent electrical shock and thermal overload protection to prevent fires due to overheating. In addition, the device includes a readily accessible power switch which can be operated by a user with a heavily gloved hand. The portable fume exhauster and dryer of the present invention is also useful for removing dust, for example, saw dust, dry wall dust and construction and remodeling dust from an area or room.

These and other objects, advantages and features of the invention will be readily seen from the following description and drawing.

### BRIEF DESCRIPTION OF THE DRAWING

FIG. 1 is a front perspective view of the fume exhauster-dryer in accordance with the present invention;

FIG. 2 is a front view of the exhauster-dryer shown in FIG. 1;

FIG. 3 is a rear view of the exhauster-dryer shown in FIG. 1;

FIG. 4 is a side elevational view of the device of FIG. 1, temporarily installed in a window of a room with an intake conduit attached, the wall and window being shown in section;

FIG. 5 is a schematic illustration of the circuitry of the device of FIG. 1;

FIG. 6 is a front view of another embodiment of the exhauster-dryer having the same front perspective view as the fume-exhauster dryer shown in FIG. 1;

FIG. 7 is a rear view of the exhauster-dryer shown in FIG. 6 having a covering mounted at the rear exhaust aperture;

FIG. 8 is a rear view of the exhauster-dryer shown in FIG. 6 having a covering mounted at the side exhaust aperture;

FIG. 9 is a rear view of still another embodiment of the exhauster-dryer having the same front perspective as the fume-exhauster dryer shown in FIG. 1.

FIG. 10 is a front perspective view of yet another embodiment of the fume exhauster-dryer in accordance with the present invention;

FIG. 11 is a sectional cut away view of a bottom corner of the fume exhauster-dryer shown in FIG. 10; and

FIG. 12 is a side elevationial view of the device of FIG. 10, installed in a window of a room with an intake conduit attached.

### DETAILED DESCRIPTION OF THE DRAWINGS

The exhauster-dryer shown in FIG. 1 comprises a portable device 10 including a housing 12 in which an in-line electric motor and fan unit 14 is mounted. Housing 12 has a front surface portion or panel 16 defining an intake opening 18; a rear portion or panel 20 defining an exhaust opening 22; side portions or panels 24, 24; a bottom portion or panel 26; and a top portion or panel 28 on which is positioned a handle 30 either integrally formed therein or if a panel, mounted thereon, and an on-off push button switch 32. Panels 16, 20, 24, 26 and 28 may be of separate pieces, for example, of sheet metal fastened together, for example by suitable fasteners, such as screws and bolts (not shown) or a pair or more of the panels can be formed of bent metal with the remaining panels similarly fastened to the first mentioned panels. Housing 12 can also be molded of a durable plastic material. The formation of housings is known in the art.

A feature of the present invention is the provision of at least one pair of supporting members positioned at the bottom of housing 12, either integrally therewith or secured thereto, such as legs 34 screwed to bottom panel 26, preferably spaced apart at the side edge margins of the panel. As shown, the preferred legs are channel shaped providing maximum stability for the device. Also as shown, adjustable members such as feet 36 are mounted to each of the at least one pair of the supporting members, e.g., legs 34, shown in the embodiment as adjacent the ends of the legs 34, which permit the device 10 to rest on the feet 36 on a floor, or on a table or other surface. Feet 36 in this embodiment are adjustable, for example by means of threaded rods 38 passing through nuts 40 and legs 34 with padded disks 42 contacting the floor or other surface. The disks 42 can be individually raised or lowered with respect to device 10 and legs 34 by advancing or retracting rods 38 through nuts 40 to compensate for slanted or uneven surfaces on which device 10 may otherwise rest. The adjustable members can be used to eliminate the marking of floors by the legs, and the potential for making lines on carpeted floors due to the bottom edges of the channels otherwise resting on the carpeting.

Housing 12, as heretofore noted, defines an intake opening 18 and an exhaust opening 22. In-line motor and fan 14 is positioned and mounted within housing 12 aligned with openings 18 and 22 so that the blades of the fan portion of 14 face opening 18 and create an air suction pulling ambient air and any fumes in the area into and through intake opening 18S Front surface portion or panel 16 defining opening 18 has a circular flange 44 extending outwardly from panel 16. Flange 44 is adapted to receive and support a grille 46 which may comprise concentric circular ring members 48 and struts 50, for example of aluminum wire, which struts support ring members 48 in position, for example by spot welding rings 48 to struts 50. Struts 50 also fasten grille 46 to flange 44, by having the ends of struts 50 bent at 90 degrees and secured to flange 44, for example, by spot welding. Grille 46 permits air and fumes to pass therethrough and into opening 18

Rear panel 20 defining opening 22 also has a circular flange 52 extending outwardly. Flange 52 need not be fitted with a grille, but a grille may be provided on flange 52, if desired, in the same manner as flange 44 supports grille 46.

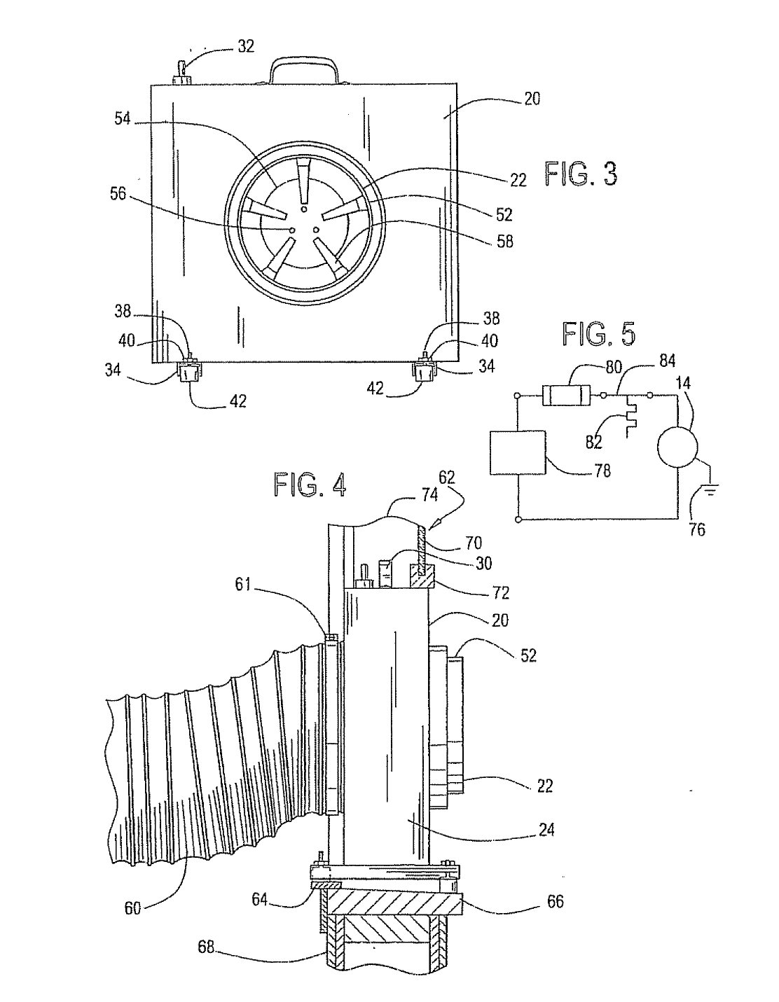

As best seen in FIG. 3 through opening 22 and flange 52, motor aid fan unit 14 includes a rotatable disk 54 bolted thereto with bolts 56 for rotation therewith, and housing 12 includes vanes 58 which are radial or inclined from the radial of the motor and fan unit shaft centerline. Disc 54 and vanes 58 enhance the flow of air and fumes through device 10.

The portable fume exhauster-carpet and floor dryer of the present invention can be readily utilized to exhaust fumes from a room in one aspect by placing the device 10 on the floor with legs 34 and feet 36 adjusted to support device 10 evenly on the surface. Desirably a flexible conduit, such as a plastic and metal hose (not shown), similar to an exhaust hose for a domestic gas clothes dryer, and similar to hose 60 shown in FIG. 4, can be attached to exhaust flange 52 by means of a metal band and hose clamp fastener (not shown, but commonly used with domestic gas clothes dryers), and led to the exterior of the room or dwelling, e.g., through a door or window. In this manner, operation of the device 10 will rapidly and efficiently remove fumes from a room. Such usage is particularly advantageous in removing fumes from a small room, such as fumes from a bathroom, for example, where tile has been installed with a mastic emitting solvent fumes or where a fixture, such as a bathtub or shower, has been restored or resurfaced, and fumes are emitted. However, the device 10 can be effectively utilized without hose or hoses 60.

In another aspect of the preferred embodiment, the device 10 may be temporarily mounted in a window, such as 62, as illustrated in FIG. 4. A window typically includes a sill 64 secured to a supporting member 66 as part of the wall 68, and a glass pane 70 in a sash 72 supported within a jamb 74. The device 10 is positioned on the sill 64 and the sash 72 is closed onto top panel 28 of housing 12 adjacent handle 30. A flexible conduit or hose 60 is secured to flange 44 of opening 18 by means of a ring clamp 61, with the other end (not shown) of hose 60 positioned near the source of the fumes to be removed. Upon operation of device 10, fumes are efficiently and rapidly exhausted from the room.

In still another aspect of the preferred embodiment, device 10 can be advantageously utilized to dry areas which are intentionally or unintentionally wet or damp, as by washing a floor or carpeting or by a flood or accidentally spilling of a liquid or by a leaking or burst water pipe. In this aspect, a flexible conduit, such as hose 60, can be secured to flange 52 of opening 22 and the device 10 can be placed on the floor or carpeting or installed in a window, as shown in FIG. 4, but with the intake opening 18 and grille 46 facing outwardly of window 62. The other end of the conduit, e.g. hose 60, can be directed to the wet or damp area of floor or carpet, and upon operation, a stream of air thus can be directed to the selected area to dry that area.

The fume exhauster-dryer of the present invention desirably is provided with an in-line electric motor and fan unit having sufficient capacity for optimum removal of fumes and drying of wet or damp areas. In this regard, it has been found that a unit 14 providing a flow of air of 548 cubic feet per minute is desirable, which flow is unrestricted by grille 46, but with grille 46 preventing small objects and fingers from entering the intake opening 18 and contacting the motor-fan unit. In addition, the device 10 of the present invention is protected against electric surges, thermal overload and electrical shock hazards by suitable circuitry as illustrated by the circuit in FIG. 5. As shown therein, the motor-fan unit 14 is grounded by ground 76 and the power from power source 78 is conducted through a fuse 80 and a thermal overload device 82 which may be a bimetallic contact element as shown operating a contact switch 84, or an overload heater element (not shown) or a solid state overload relay as shown in U.S. Pat. No. 5,222,009, incorporated herein by reference. In addition, the use of a push button on-off switch 32, allows the operator to operate device 10 while wearing protective clothing, erg heavy gloves. By use of the illustrated circuitry, the device and the operator are protected against electrical shock, power surges and thermal overloads.

In another aspect, not illustrated, a variable speed control can be incorporated into the circuitry, with a dial position on the top or side panel of housing 12, to permit the speed and hence the air flow, of the device at a level desired for the particular application for which the device is to be employed.

In still another aspect, device 10 of the present invention may be utilized to import air into a contaminated room or exhausted from a contaminated room or area over a considerable distance, for example 50 feet or more, through use of flexible hoses, such as hose 60. In addition, multiple devices 10 can be connected through such hoses to import air or exhaust fumes over longer distances, such as in buildings where windows are not openable.

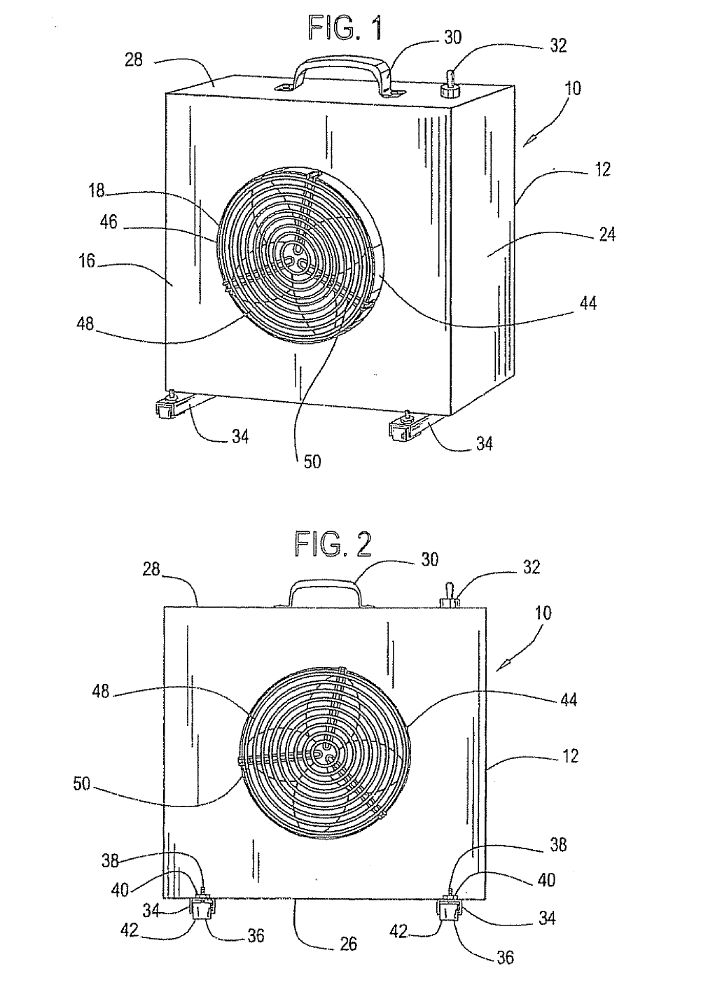

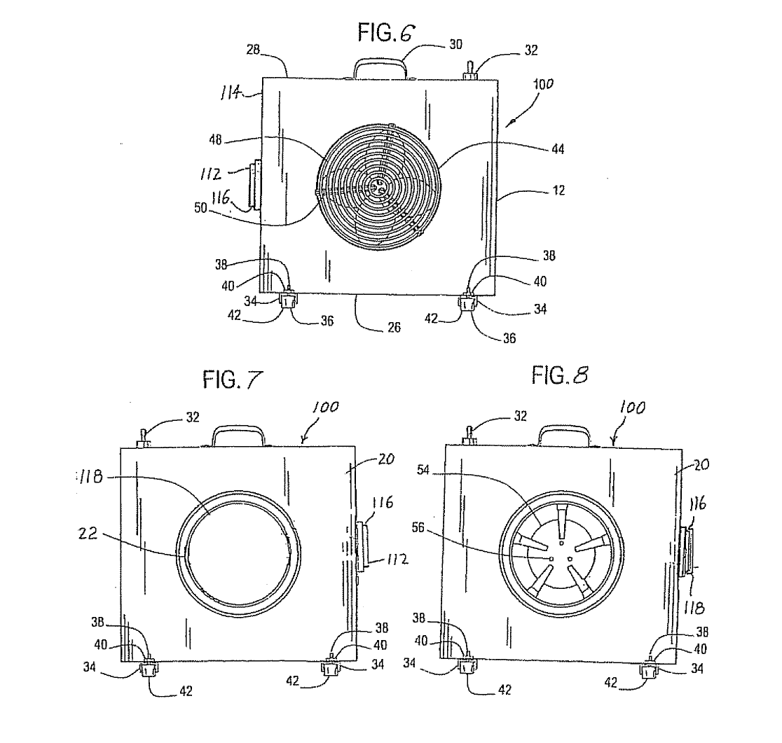

The exhauster-dryer 100 shown in FIGS. 6-8, and having the same front perspective view as the embodiment of FIG. 1, has many of the same components as in the embodiment shown in FIGS. 1-5, and therefore those common components are illustrated in FIGS. 6-8 using the same reference numerals as in FIGS. 1-5, and the description thereof in connection with the exhaust-dryer 10 are the same. Therefore, these common components are not described here for the sake of brevity. Additionally, exhaust-dryer 100 includes supporting members or legs 34 and adjustable feet 36, rods 38, nuts 40 and discs 42, providing adjustability in supporting the exhauster-dryer 100 on various surfaces as noted above. Further, exhauster-dryer 100 includes an on-off push button switch 32 operable by an operator wearing protective clothing, such as heavy gloves, and protective circuitry against electric surges, thermal overload and electrical shock hazards, such as by the circuit illustrated in FIG. 5; and may include a variable speed control as described above.

Exhauster-dryer 100 differs from exhauster-dryer 10 in having an exhaust aperture designated by reference numeral 112 defined in a side portion or panel 114, as best shown in FIGS. 6-8. Exhaust aperture 112 defined in side portion or panel 114 may be either in lieu of exhaust opening 22 in rear portion or panel 20, or preferably may be in addition thereto as shown. As in the case of the embodiment shown in FIG. 1, side portion or panel 114 can be a separate piece in place of one side of the side panels 24, for example, of sheet metal fastened to bottom panel 26, top panel 28, front panel 16 and rear panel 20; or can be integrally formed as a portion of housing 12, particularly when housing 12 is molded of a durable plastic. Side portion or panel 114 can be either the right side or the left side portion or panel of housing 12 as desired.

The exhaust aperture 112 defined in portion or panel 114, like the exhaust opening 22 in panel 20, has a circular flange 116 extending outwardly from the portion or panel 114. Under some circumstances, such as drying of a surface within a space, such as a room, without any need to exhaust air or fumes from the space, both opening 22 and aperture 112 may remain open, i.e., uncovered, for maximum exhaust. However, it is more often desirable to utilize either the exhaust opening 22 in rear panel 20 or the exhaust aperture 112 in side portion or panel 114. To accomplish the latter, a cover 118 may be mounted either to flange 52 at opening 22 or to the flange 116 aperture 112 so that only the other opening or aperture is used to exhaust the air or fumes, Cover 118 can be formed desirably of a substantially inflexible polymeric material, such as polypropylene, with an upturned rim to closely fit about flange 52 or flange 16, so as to be retained thereon against the force of air being exhausted through the respective opening or aperture. Optionally, a circular clamp (not shown) such as that used to mount a flexible conduit, such as a ring clamp 61 (FIG. 4), can be used to secure cover 118 to flange 52 or 116.

As in the case of exhauster-dryer 10, in exhaust-dryer 100 flange 44 at intake opening 18 and flanges 52 at exhaust opening 22, as well as flange 116 side exhaust aperture 112 may each support a grille, such as grille 44 shown in FIG. 6, mounted in the manner explained above. Also, each such flange may support an end of a flexible conduit, such as hose 60 shown in FIG. 4, and may be clamped thereon by means of a metal band and hose clamp, such as clamp 61 (FIG. 4) for the applications described above.

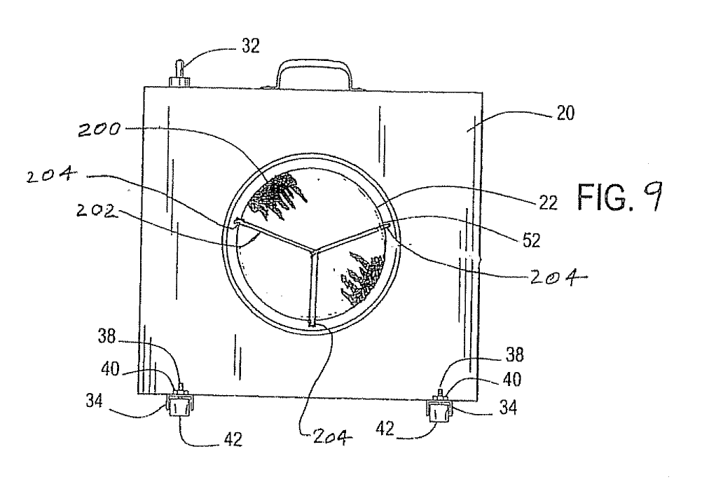

In still another embodiment of the exhauster-dryer, as shown in FIG. 9, the exhauster-dryer 10 may include a filter 200 secured to flange 52 at exhaust opening 22, as will be hereinafter described. The other components and their arrangement in this embodiment are the same as in the first embodiment described above, and are not repeated here for the sake of brevity.

Filter 200 is desirably a disk of expanded polyester or polyester foam with sufficient thickness and stiffness, for example, of polyester foam approximately ⅜ to approximately ½ inch in thickness, so as to resist the force of the air passing through aperture 22. Filter 200 is supported by a supporting flame 202, which, as shown in FIG. 9, is a wire frame, preferably of stainless steel or annodized metal wire, having three or more legs to retain filter 200 between flame 202 and the outer rim of flange 52. The distal portions or ends 204 of the legs of flame 202 may be welded to flange 52 or formed to snugly fit about flange 52 to resist the force of the air passing through opening 22 when the disk 200 is supported within flame 202. Filter 200 can be inserted in frame 202 after it is mounted on flange 52, by inserting filter 200 through the open top of the frame 202.

Additionally, a filter (not shown) similar to filter 200, and a supporting frame (not shown) similar to frame 202 can be secured to flange 116 at exhaust aperture 112 in the embodiment illustrated in FIGS. 6-8. A filter and frame, like filter 200 and frame 202 is applicable to the embodiment illustrated in FIGS. 6-8 in connection with flange 116 and exhaust aperture 112 is applicable, whether or not the exhaust opening 22 and the flange 52 are present in the fume exhauster-dryer.

The embodiment of the present invention having a filter, such as filter 200, secured to a flange of an exhaust opening 22 and/or an exhaust aperture 112, is particularly useful in trapping particulate matter from the air stream passing through that opening or aperture. In this manner, the amount of dust and other particulate matter which would otherwise mar or be deposited on a wet surface, particularly when the fume-exhauster and dryer is utilized to dry a polished or freshly coated surface, will be substantially reduced, if not eliminated.

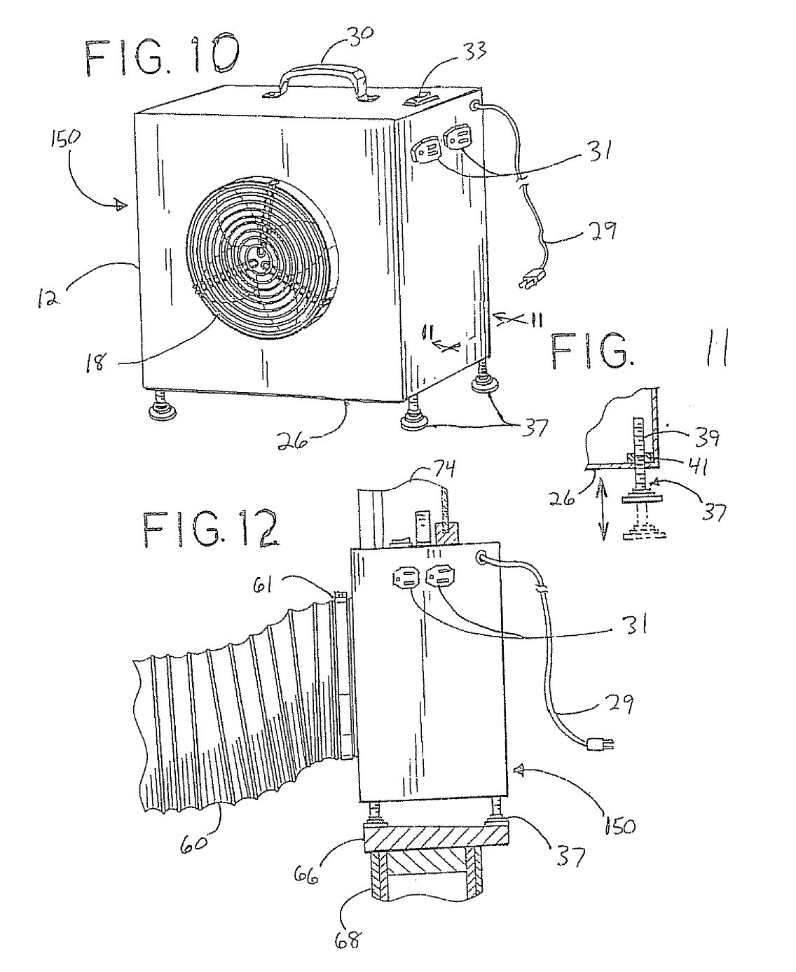

The exhauster-dryer 150 shown in FIGS. 10-12 has many of the same components as in the embodiment shown in FIGS. 1-5, and therefore those common components are illustrated in FIGS. 10-12 using the same reference numerals as in FIGS. 1-5, and the structure and function thereof are the same. Therefore, these common components are not described here for the sake of brevity. Additionally, exhauster-dryer 150 includes individually adjustable feet 37 providing adjustability in supporting the exhauster-dryer 150 on various surfaces as noted above. Further, exhauster-dryer 150 includes an on-off rocker switch 33 operable by an operator wearing protective clothing, such as heavy gloves, and protective circuitry against electric surges, thermal overload and electrical shock hazards, such as by the circuit illustrated in FIG. 5; and may include a variable speed control as described above.

Exhauster-dryer 150 differs from exhauster-dryer 10 in having individually adjustable feet 37 attached directly to the bottom panel 26 of the housing 12, providing increased stability with less weight and cost. As illustrated by FIG. 11, the shaft 39 of each adjustable foot 37 has external threads and is threaded into an internally threaded nut 41 that is secured to the inside of the bottom panel 26. The adjustable feet 37 can be rotated in one direction to shorten the length of the adjustable feet 37 extending from the bottom panel 26 and rotated in the opposite direction to increase the length of the adjustable feet 37 extending from the bottom panel 26, thereby allowing the exhaust-dryer 10 to be made level on a variety of surfaces having a variety of contours.

Exhauster-dryer 150 also differs from exhauster-dryer 10 in that a rocker switch 3 is used to turn the exhaust-dryer 10 on or off. The rocker switch 33 is easy to operate even if the operator is wearing protective clothing such as heavy gloves. In addition, exhaust-dryer 150 has a power cord 29 extending from the side panel 24 of the housing 12 which allows the exhauster-dryer 150 to be plugged in to any appropriate power source. Further, exhaust-dryer 150 has two auxiliary power outlets 31 mounted in the same side panel 24 as the power cord 29. The auxiliary power outlets 31 allow the operator to plug in additional devices such as power tools or radio directly to the exhaust-dryer 150, eliminating the need for additional extension cords.

While particular embodiments of the portable fume exhauster-carpet and floor dryer the invention have been shown and described, it will be appreciated by those skilled in the art that changes and modifications may be made thereto without departing from the invention in its broader aspects.

What is claimed is:

1. A portable fume exhauster and dryer adapted to be supported on a surface, comprising:
a housing having at least a front, a side, a rear and a bottom;
said housing including an intake aperture in said front and an exhaust aperture in said real;
a motor driven fan mounted in said housing for moving air therethough from said intake aperture to said exhaust aperture; and
at least one individually vertically adjustable member positioned at said bottom adapted to adjustably support the fume exhauster and dryer on the surface.

2. The portable fume exhauster and dryer of claim 1, wherein said housing has at least one flange extending outwardly with respect to at least one of said apertures in said housing;

3. The portable fume exhauster and dryer of claim 2, wherein said at least one flange is adapted to support one end of a conduit capable of passing air therethrough.

4. The portable fume exhauster and dryer of claim 2, wherein said at least one flange is adapted to support a grille mounted thereto.

5. The portable fume exhauster and dryer of claim 4, wherein a grille is removably mounted to said at least one flange, whereby the at least one aperture in said housing is covered by said grille when mounted to said flange.

6. The portable fume exhauster and dryer of claim 2, wherein said flange extending outwardly with respect to said aperture in the rear of said housing is adapted to support a cover mounted thereto, whereby the said cover is capable of substantially reducing the exhaust of air through said aperture.

7. The portable fume exhauster and dryer of claim 6, wherein said flange is adapted to support one end of a conduit capable of passing air therethrough, is adapted to support a grille removably mounted thereto, and is adapted to support a cover mounted thereto, whereby the said cover is capable of substantially reducing the exhaust of air through said aperture.

8. The portable fume exhauster and dryer of claim 1, wherein each of said apertures has a flange extending outwardly with respect to said housing.

9. The portable fume exhauster and dryer of claim 8, wherein said flanges are each adapted to support one end of a conduit capable of passing air therethrough.

10. The portable fume exhauster and dryer of claim 8, wherein said flanges are each adapted to support a grille mounted thereto.

11. The portable fume exhauster and dryer of claim 8, wherein said flanges are each adapted to support one end of a conduit capable of passing air therethrough and are each adapted to support a grille removably mounted thereto.

12. The portable fume exhauster and dryer of claim 1, wherein said housing includes a top surface portion and a handle thereon.

13. The portable fume exhauster and dryer of claim 12 wherein said handle is integral with said top surface portion.

14. The portable fume exhauster and dryer of claim 12, wherein said handle is mounted on said top surface portion.

15. The portable fume exhauster and dryer of claim 1, wherein said motor driven fan mounted in said housing for moving air therethrough is electrically controlled by a switch mounted on said housing.

16. The portable fume exhauster and dryer of claim 15, wherein said switch is a rocker switch capable of being operated by an operator wearing protective clothing.

17. The portable fume exhauster and dryer of claim 1, wherein said motor drive fan mounted in said housing for moving air therethrough is electrically controlled by electrical circuitry which includes elements for protection against electric surges, thermal overload and electric shock.

18. The portable fume exhauster and dryer of claim 17, wherein said circuitry includes a variable speed control to vary the speed of the motor driven fan.

19. The portable fume exhauster and dryer of claim 2, wherein said at least one flange has a filter support secured thereto and a filter member positionable within said filter support capable of reducing the amount of particulate matter passing through the aperture with respect to the said at least one flange.

20. The portable fume exhauster and dryer of claim 1, wherein a power cord extends from said side.

21. The portable fume exhauster and dryer of claim 1, wherein at least one power outlet is mounted in said side.

22. The portable fume exhauster and dryer of claim 1, wherein the said at least one individually vertically adjustable member positioned at said bottom is a foot with a threaded shaft.

23. The portable fume exhauster and dryer of claim 1, wherein four individually vertically adjustable members are positioned at said bottom.

24. The portable fume exhauster and dryer of claim 23, wherein the said four individually vertically adjustable members positioned at said bottom are each a foot with a threaded shaft.
